(19) United States
(12) Patent Application Publication
(10) Pub. No.: US 2006/0150639 A1
(43) Pub. Date: Jul. 13, 2006

(54) Cable cooling system

(76) Inventors: Jalal Hunain Zia, Grand Island, NY (US); Nancy Jean Lynch, North Tonawanda, NY (US); John Henri Royal, Grand Island, NY (US)

Correspondence Address: PRAXAIR, INC.;LAW DEPARTMENT - M1 557, 39 OLD RIDGEBURY ROAD, DANBURY, CT, 06810-5113, US

(21) Appl. No.: 11/033,640

(22) Filed: Jan. 13, 2005

(51) Int. Cl. F17C 7/02

(52) U.S. Cl. 62/50.1

(57) ABSTRACT

A system for providing cooling to cable such as superconducting cable which employs at least one cryocooling station or consolidated cryocooler/pumping station which processes coolant involving multiple cable lengths.

### TECHNICAL FIELD

This invention relates generally to the provision of cooling or refrigeration to electrical transmission cables, and is particularly useful for providing cooling or refrigeration to superconducting cable.

### BACKGROUND ART

Electrical transmission through cables generates heat which reduces the efficiency of the electrical transmission, particularly over relatively long distances. This is especially the case when the electrical transmission cable is a superconducting cable.

Superconductivity is the phenomenon wherein certain metals, alloys and compounds, such as YBCO, REBCO and BSCCO, at very low temperatures lose electrical resistance so that they have infinite electrical conductivity. It is important in the use of superconducting cable to transmit electricity, that the cooling, i.e. refrigeration, provided to the superconducting cable not fall below a certain level lest the cable lose its ability to superconduct and the electrical transmission be compromised. While systems which can provide the requisite refrigeration to superconducting cable are known, such systems are costly, complicated and subject to breakdown.

Accordingly, it is an object of this invention to provide an improved system for more effectively providing cooling to electrical transmission cable, particularly over relatively long distances.

It is another object of this invention to provide an improved system for more effectively providing cooling to superconducting cable.

### SUMMARY OF THE INVENTION

The above and other objects, which will become apparent to those skilled in the art upon a reading of this disclosure, are attained by the present invention, one aspect of which is:

Apparatus for providing cooling to cable comprising:

(A) a cryocooler/pumping station, a first length of cable, and a second length of cable;

(B) means for passing coolant from the first length of cable to the cryocooler/pumping station, and means for passing coolant from the cryocooler/pumping station to the first length of cable; and

(C) means for passing coolant from the second length of cable to the cryocooler/pumping station, and means for passing coolant from the cryocooler/pumping station to the second length of cable.

Another aspect of the invention is:

Apparatus for providing cooling to cable comprising:

(A) a cryocooling station, a first length of cable, and a second length of cable;

(B) means for passing coolant from the first length of cable to the cryocooling station, and means for passing coolant from the cryocooling station to the first length of cable; and

(C) means for passing coolant from the second length of cable to the cryocooling station, and means for passing coolant from the cryocooling station to the second length of cable.

A further aspect of the invention is:

Apparatus for providing cooling to cable comprising a cryocooling station, a first length of cable, a second length of cable, means for passing coolant from the first length of cable to the cryocooling station, and means for passing coolant from the cryocooling station to the second length of cable.

Yet another aspect of the invention is:

Apparatus for providing cooling to cable comprising:

(A) a plurality of cable lengths including an initial length, a final length, and at least one intermediate length positioned between the initial length and the final length;

(B) a first cryocooler/pumping station and means for passing coolant from the first cryocooler/pumping station to the initial length of cable;

(C) an intermediate cryocooler, means for passing coolant from the initial length of cable to the intermediate cryocooler, and means for passing coolant from the intermediate cryocooler to an intermediate length of cable; and

(D) a second cryocooler/pumping station, means for passing coolant from an intermediate length of cable to the second cryocooler/pumping station, means for passing coolant from the second cryocooler/pumping station to the final length of cable, and means for passing coolant from the final length of cable to the first cryocooler/pumping station.

As used herein the term “superconducting cable” means cable made of material that loses all of its resistance to the conduction of an electrical current once the material attains some cryogenic temperature.

As used herein the term “refrigeration” means the capability to reject heat from a subambient temperature entity.

As used herein the term “indirect heat exchange” means the bringing of entities into heat exchange relation without any physical contact or intermixing of the entities with each other.

As used herein the term “direct heat exchange” means the transfer of refrigeration through contact of cooling and heating entities.

As used herein the term “subcooled” means a liquid which has been cooled to be at a temperature lower than the saturation temperature of that liquid for the existing pressure.

As used herein the term “cable length” means a volume which contains a length of electrical transmission cable and is capable of containing coolant.

As used herein the term “cryocooler” means a refrigerating machine able to achieve and maintain cryogenic temperatures.

As used herein the term “cryocooling station” means an arrangement comprising a cryocooler that provides refrigeration to a coolant.

As used herein the term “cryocooler/pumping station” means an arrangement comprising a cryocooler and a pump for receiving coolant, providing refrigeration to the coolant, increasing the pressure of the coolant, and transmitting the coolant.

### BRIEF DESCRIPTION OF THE DRAWINGS

FIG. 1 is a simplified schematic representation of one preferred embodiment of the cable cooling system of this invention.

FIG. 2 is a simplified schematic representation of another preferred embodiment of the cable cooling system of this invention.

### DETAILED DESCRIPTION

In general, the invention comprises a defined consolidation of cryocoolers or cryocoolers and pumps over an electrical transmission line or cable, and the positioning of such resulting cryocooler or cryocooler/pumping stations to receive coolant from and transmit coolant to different lengths of cable. The invention enables a reduction in the overall number of cryocoolers and pumps to service any given amount of transmission cable by both pressurizing and cooling the coolant, thereby increasing the effectiveness of the refrigeration transmittal to the cable.

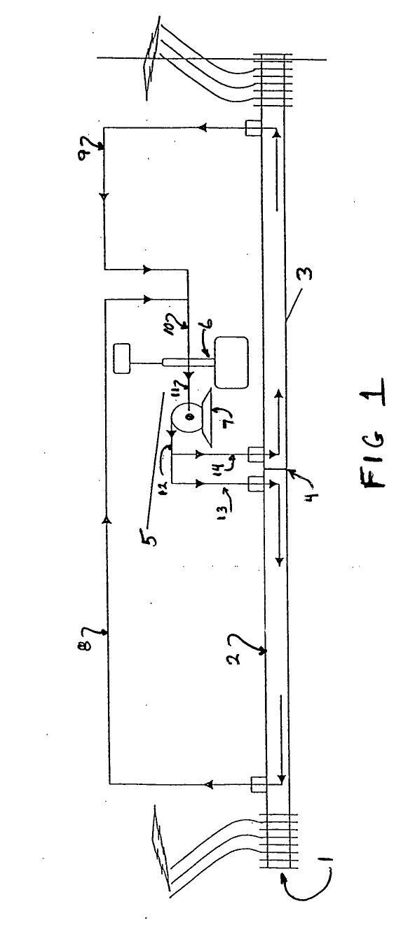

The invention will be described in greater detail with reference to the Drawings. Referring now to FIG. 1, there is illustrated a section of electrical transmission line 1 having a first length of cable 2 and a second length of cable 3 which, in the embodiment of the invention illustrated in FIG. 1, are separated by divider 4, although such a divider need not be employed. It is understood that over the course of the entire transmission line there may be a number of sections such as section 1 illustrated in FIG. 1. In a particularly preferred embodiment of the invention the cable is a superconducting cable. Examples of superconducting cable may be found in U.S. Pat. No. 6,596,945 and U.S. Pat. No. 6,794,579.

Typically each of the first cable length and the second cable length is within the range of from 10 to 5400 feet. Cryocooler/pumping station 5 comprises cryocooler 6 and pump 7. Coolant, which is preferably liquid cryogen such as liquid nitrogen, is passed from first cable length 2 in stream or line 8 to cryocooler/pumping station 5. Similarly coolant is passed from second cable length 3 in line 9 to cryocooler/pumping station 5. In the embodiment of the invention illustrated in FIG. 1, coolant lines 8 and 9 are combined to form coolant line 10 prior to passage to cryocooler/pumping station 6.

Cryocooler 6 of cryocooler/pumping station 5 may be any effective cryocooler such as a pulse tube cryocooler, a Gifford-McMahon cryocooler or a reverse Brayton cryocooler. Cryocooler 6 provides cooling or refrigeration to the coolant in line 10. When the coolant is a liquid cryogen the cooling results in the subcooling of the liquid cryogen. When the cable is a superconducting cable the preferred coolant is liquid nitrogen and the resulting subcooled liquid nitrogen in line 11 has a temperature generally within the range of from 64 to 90K.

Coolant in line 11 which has been cooled by the cryocooler is pumped by pump 7 of the cryocooler/pumping station 5 to a higher pressure. When the coolant is liquid nitrogen, the pressured subcooled liquid nitrogen in line 12 from the liquid pump has a pressure generally within the range of from 15 to 150 psig. The pressurized refrigerated coolant from the cryocooler/pumping station 5 is then passed in line or conduit 13 to first cable length 2 and in line or conduit 14 to second cable length 3, wherein the coolant flows as indicated by the flow arrows and provides cooling to the cable, emerging therefrom in aforedescribed streams 8 and 9 respectively for renewal of the coolant cycle.

The cooling and pressurization of the coolant in one consolidated station enables the refrigerated coolant to retain its refrigerating capacity longer thus reducing the overall number of cryocoolers and pumps needed over the total length of the transmission line. Moreover, the positioning of a cryocooler/pumping station to process coolant fluid from two different lengths of cable further reduces the overall number of required cryocoolers and pumps. This reduces the cost, increases the reliability and improves the efficiency of the cable cooling system. However, benefit is still achieved if the station of FIG. 1 is a cryocooling station as this will also reduce the overall number of cryocoolers required for the transmission line, thus reducing the cost, increasing the reliability and improving the efficiency of the overall cable cooling system.

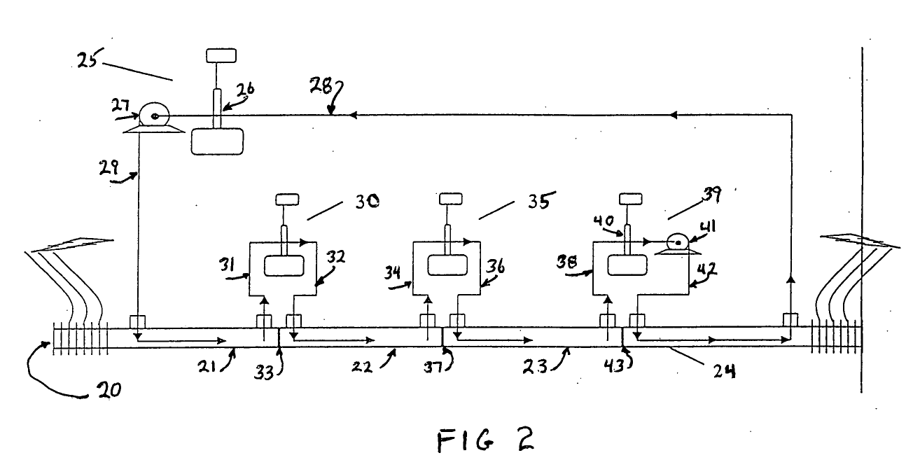

FIG. 2 illustrates another embodiment of the invention which is also preferably employed to cool superconducting cable using subcooled liquid nitrogen as the coolant. The embodiment illustrated in FIG. 2 employs a section of electrical transmission line 20 having an initial cable length 21, a first intermediate cable length 22, a second intermediate cable length 23 and a final cable length 24. It is understood that over the course of the entire transmission line there may be one or more sections such as section 20 illustrated in FIG. 2.

First cryocooler/pumping station 25 comprising cryocooler 26 and pump 27 receives coolant in line or conduit 28 and processes this coolant in a manner similar to that described in conjunction with FIG. 1, to produce refrigerated pressurized coolant. The refrigerated pressurized coolant is passed from first cryocooler/pumping station 25 in line 29 to initial cable length 21 wherein it provides cooling to the cable. Coolant from initial cable length 21 is passed to first intermediate cryocooler, i.e. cryocooling station, 30 in line 31 wherein it is cooled, preferably subcooled, and passed in line 32 to first intermediate cable length 22 which, in this embodiment, is separated from initial cable length 21 by divider 33. It is understood, however, that the use of such physical dividers is optional in the general practice of this invention. The coolant passing through first intermediate cable length 22 provides cooling to the cable and emerges from first intermediate cable length 22 in line 34.

The warmed coolant in line 34 is passed to second intermediate cryocooler, i.e. cryocooling station, 35 and receives refrigeration from this cryocooler to produce cooled, preferably subcooled, coolant which is passed in line 36 to second intermediate cable length 23 which is separated from first intermediate cable length 22 by divider 37. The coolant passing through second intermediate cable length 23 provides cooling to the cable and emerges from second intermediate cable length 23 in line 38.

The warmed coolant in line 38 is passed to second cryocooler pumping station 39 which comprises cryocooler 40 and pump 41 wherein it is processed in a manner similar to that described above, emerging therefrom as pressurized refrigerated coolant in line 42. The pressurized refrigerated coolant, which is preferably subcooled, is then passed in line 42 to final cable length 24 which is separated from second intermediate cable length 23 by divider 43. In the practice of the embodiment of invention illustrated in FIG. 2, the number of intermediate cable lengths and the number of intermediate cryocoolers need not be two as specifically illustrated in FIG. 2, but rather may be one or more.

The pressurized refrigerated coolant from line 42 passes through final cable length 24 and provides cooling to the cable. The warmed coolant is passed out of final cable length 24 in line 28 and is passed to first cryocooler/pumping station 25 as the coolant cycle begins anew.

As is the case with the embodiment of the invention illustrated in FIG. 1, the embodiment of the invention illustrated in FIG. 2 involving consolidated refrigeration and pressurization of the coolant enables the coolant to retain the refrigerating capacity longer, and the flow of coolant to and from different lengths of cable to a cryocooler/pumping station, serve, in combination, to reduce the overall number of cryocoolers and pumps needed over the entire transmission line, thus reducing costs and improving efficiency.

Although the invention has been described in detail with reference to certain preferred embodiments, those skilled in the art will recognize that there are other embodiments of the invention-within the spirit and scope of the claims. For example the cable need not be superconducting cable. Conventional cables will also benefit from the practice of this invention. The coolant, in addition to cryogenic nitrogen, may also comprise cryogenic helium, argon or multicomponent refrigerants, and non-cryogenic water or oil. The coolant need not be subcooled and indeed may be in the gaseous state and the cooling may take place by a change of phase. The cryocooler may be any effective refrigeration system including pulse tube refrigerators, mixed gas refrigerators, vacuum refrigerators and turbine expanders.

1. Apparatus for providing cooling to cable comprising:
(A) a cryocooler/pumping station, a first length of cable, and a second length of cable;
(B) means for passing coolant from the first length of cable to the cryocooler/pumping station, and means for passing coolant from the cryocooler/pumping station to the first length of cable; and
(C) means for passing coolant from the second length of cable to the cryocooler/pumping station, and means for passing coolant from the cryocooler/pumping station to the second length of cable.

2. The apparatus of claim 1 wherein the cable is superconducting cable.

3. The apparatus of claim 1 wherein the coolant is liquid cryogen.

4. The apparatus of claim 3 wherein the liquid cryogen is liquid nitrogen.

5. Apparatus for providing cooling to cable comprising:
(A) a cryocooling station, a first length of cable, and a second length of cable;
(B) means for passing coolant from the first length of cable to the cryocooling station, and means for passing coolant from the cryocooling station to the first length of cable; and
(C) means for passing coolant from the second length of cable to the cryocooling station, and means for passing coolant from the cryocooling station to the second length of cable.

6. The apparatus of claim 5 wherein the cable is superconducting cable.

7. The apparatus of claim 5 wherein the coolant is liquid cryogen.

8. The apparatus of claim 7 wherein the liquid cryogen is liquid nitrogen.

9. Apparatus for providing cooling to cable comprising:
(A) a plurality of cable lengths including an initial length, a final length, and at least one intermediate length positioned between the initial length and the final length;
(B) a first cryocooler/pumping station and means for passing coolant from the first cryocooler/pumping station to the initial length of cable;
(C) an intermediate cryocooler, means for passing coolant from the initial length of cable to the intermediate cryocooler, and means for passing coolant from the intermediate cryocooler to an intermediate length of cable; and
(D) a second cryocooler/pumping station, means for passing coolant from an intermediate length of cable to the second cryocooler/pumping station, means for passing coolant from the second cryocooler/pumping station to the final length of cable, and means for passing coolant from the final length of cable to the first cryocooler/pumping station.

10. The apparatus of claim 9 wherein the cable is superconducting cable.

11. The apparatus of claim 9 wherein the coolant is liquid cryogen.

12. The apparatus of claim 11 wherein the liquid cryogen is liquid nitrogen.

13. The apparatus of claim 9 comprising two intermediate lengths of cable positioned between the initial length and the final length.

14. The apparatus of claim 13 comprising an additional intermediate cryocooler, means for passing coolant from one intermediate length of cable to the additional intermediate cryocooler, and means for passing coolant from the additional intermediate cryocooler to the other intermediate length of cable.

15. Apparatus for providing cooling to cable comprising a cryocooling station, a first length of cable, a second length of cable, means for passing coolant from the first length of cable to the cryocooling station, and means for passing coolant from the cryocooling station to the second length of cable.

16. The apparatus of claim 15 wherein the cable is superconducting cable.

17. The apparatus of claim 15 wherein the coolant is liquid cryogen.

18. The apparatus of claim 17 wherein the liquid cryogen is liquid nitrogen.
